(19) United States
(12) Patent Application Publication
(10) Pub. No.: US 2015/0112946 A1
(43) Pub. Date: Apr. 23, 2015

(54) COMPUTING DEVICE AND DATA RECOVERY METHOD FOR DISTRIBUTED FILE SYSTEM

(71) Applicants: GDS Software (ShenZhen) Co.,Ltd, Shenzhen (CN); HON HAI PRECISION INDUSTRY CO., LTD., New Taipei (TW)

(72) Inventors: MING-CHUAN KAO, New Taipei (TW); ZHONG-WEI LI, Shenzhen (CN)

(73) Assignees: HON HAI PRECISION INDUSTRY CO., LTD., New Taipei (TW); GDS SOFTWARE (SHENZHEN) CO.,LTD, Shenzhen (CN)

(21) Appl. No.: 14/512,586

(22) Filed: Oct. 13, 2014

(30) Foreign Application Priority Data
Oct. 17, 2013 (CN) 201310487760.5

(51) Int. Cl. G06F 11/14

(52) U.S. Cl. CPC G06F 11/1469; G06F 11/1464
USPC 707/654

(57) ABSTRACT

A data recovery method includes executing a recovery program of the DFS to periodically generate backup data of the DFS. In response to received operations of a user on a client device, information in relation to the received operations is stored in a main computing device. When a master node of the DFS is running abnormally, the data recovery program is executed to restore the data of the DFS using backup data having a creation time closest to the current time. Specified operations with later creation times are determined. Information in relation to the specified operations is acquired from the stored information. According to the acquired information of the specified operations, each of the specified operations is re-executed.

### CROSS-REFERENCE TO RELATED APPLICATIONS

This application claims priority to Chinese Patent Application No. 201310487760.5 filed on Oct. 17, 2013, the contents of which are incorporated by reference herein.

### FIELD

Embodiments of the present disclosure relate to data processing technology, and particularly to data recovery method for a distributed file system (DFS) using a computing device.

### BACKGROUND

In a distributed file system (DFS), a data recovery program may be used to backup data of the DFS. When a master node (e.g., a NameNode of the Hadoop™) of the DFS is abnormal, the data of the DFS can to be restored from the data recovery program.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a diagrammatic view of one embodiment of a computing device including a recovery system.

FIG. 2 is a diagrammatic view of one embodiment of function modules of the recovery system in the computing device of FIG. 1.

FIG. 3 is a flowchart of one embodiment of a data recovery method for a distributed file system (DFS) in the computing device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

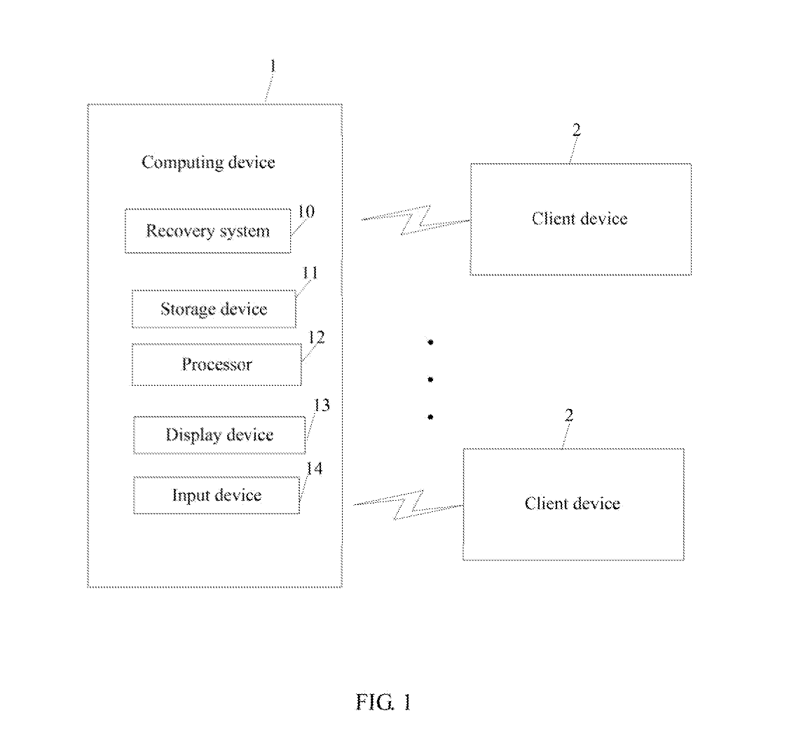

FIG. 1 illustrates one embodiment of a computing device. The computing device 1 is connected to a plurality of client devices 2. Depending on the embodiment, the computing device 1 includes a recovery system 10. The computing device 1 includes, but is not limited to, a storage device 11, at least one processor 12, a display device 13, and an input device 14. The computing device 1 can be a server, a computer, a smart phone, a personal digital assistant (PDA), or other computing device. FIG. 1 illustrates only one example of the computing device that can include more or fewer components than illustrated, or have a different configuration of the various components in other embodiments.

The storage device 11 stores data of a distributed file system (DFS). A user of the client device 2 can do operations on the data of the DFS, such as modify, add to, or delete the data of the DFS. The storage device 11 also stores a recovery program of the DFS and data of master nodes of the DFS. The recovery program can be invoked to generate and store backup data of the DFS. For example, the DFS can be Hadoop™, the recovery program can be a SecondaryNameNode process of the Hadoop™, the master node of the DFS can be a NameNode of the Hadoop™. In other embodiments, the computing device 1 can be also connected to another computing device. The computing device 1 stores the recovery program. The other computing device stores data of the master nodes of the DFS. The other computing device can be a server, a computer, a smart phone, a personal digital assistant (PDA), or other computing device.

The recovery system 10 can periodically generate backup data of the DFS using the data recovery program. When a master node of the DFS is abnormal, the recovery system 10 can restore the data of the DFS by using the backup data of the DFS and re-execute operations on the DFS executed after creation time of the backup data by the user from the client device.

In at least one embodiment, the storage device 11 can include various types of non-transitory computer-readable storage mediums, such as a hard disk, a compact disc, a digital video disc, or a tape drive. The display device 13 can display images and videos, and the input device 14 can be a mouse, a keyboard, or a touch panel.

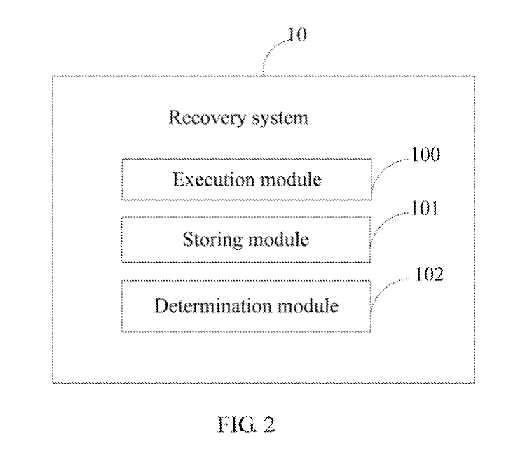

FIG. 2 illustrates an embodiment of function modules of the recovery system. In at least one embodiment, the recovery system 10 can include an execution module 100, a storing module 101, and a determination module 102. The function modules 100, 101, and 102 can include computerized codes in the form of one or more programs, which are stored in the storage device 11. The at least one processor executes the computerized codes to provide functions of the function modules 100, 101, and 102.

The execution module 100 executes the data recovery program of the DFS to periodically (e.g., every hour) generate backup data of the DFS, and stores creation time of the backup data. The execution module 100 stores the backup data of the DFS in the storage device 11.

The user of the client device 2 can do operations on data of the DFS. The computing device 1 can receive the operations. In response to the received operations, the storing module 101 stores information in relation to the received operations. The storing module 101 can store the information by a way of log. The stored information includes, but is not limited to, operation time and a name of a client device corresponding to each of the received operations.

The received operations include a data adding operation and a data modification operation. The data adding operation includes uploading data to the DFS. The data modification operation includes, but is not limited to, creating a folder, data cancellation and modifying a name of a file. In at least one embodiment, the information in relation to each of the received operations can be stored as followed. The storing module 101 determines whether one received operation is the data adding operation or the data modification operation. When the received operation is the data adding operation, the storing module 101 backups added data into the storage device 11. When the received operation is the data modification operation, the storing module 101 stores modified data in the storage device 11.

The determination module 102 determines whether a master node of the DFS is abnormal. When the DFS runs normally, the determination module 102 determines that the master node of the DFS is normal. When the DFS cannot run or runs abnormally, the determination module 102 determines that the master node of the DFS is abnormal.

When the master node of the DFS is abnormal, the execution module 100 selects backup data whose creation time is closest to current time, from the backup data of the DFS. The execution module 100 executes the data recovery program to restore the data of the DFS using the selected backup data.

The determination module 102 determines specified operations whose operation time is later than the creation time of the selected backup data from the received operations and acquires information in relation to the specified operations from the stored information.

The execution module 100 re-executes each of the specified operations according to the acquired information in relation to the specified operations. In at least one embodiment, each of the specified operations can be re-executed as followed. The execution module 100 determines one specified operation is the data adding operation or data modification operation. When the specified operation is the data adding operation, the execution module 100 acquires added data corresponding to the specified operation from the storage device 11, and re-executes the specified operation according to the added data corresponding to the specified operation. For example, the execution module 100 can re-execute the specified operation by adding the added data in the data of DFS according to information in relation to the specified operation (e.g., a data insertion position). When the specified operation is the data modification operation, the execution module 100 acquires modified data corresponding to the specified operation from the storage device, and re-executes the specified operation according to the modified data corresponding to the specified operation. For example, the execution module 100 can re-execute the specified operation by replacing corresponding data in the data of DFS using the modified data.

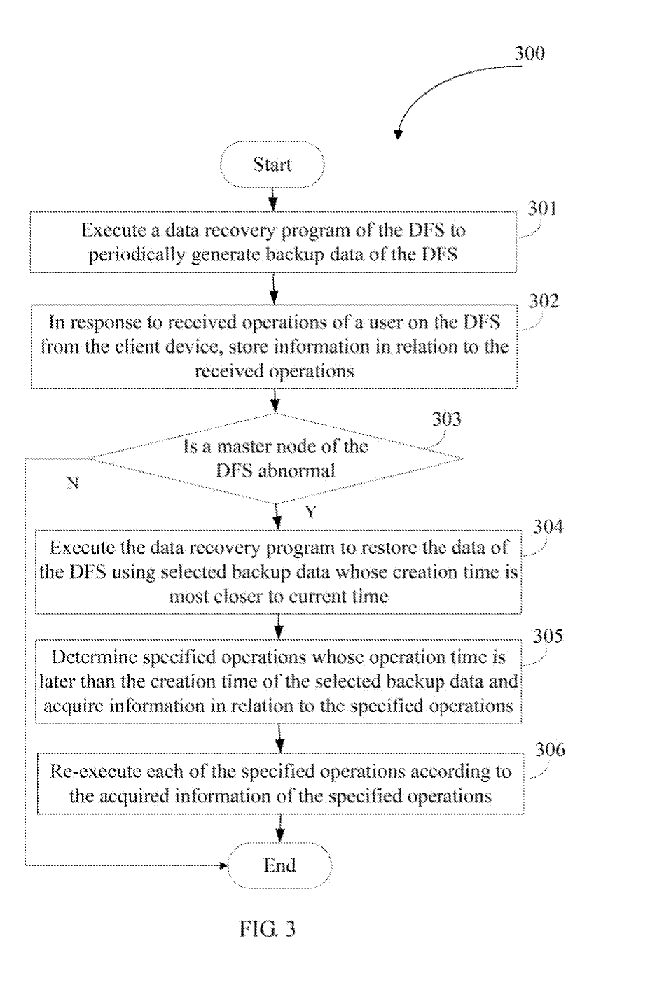

FIG. 3 illustrates a flowchart which is presented in accordance with an example embodiment. The example method 300 is provided by way of example, as there are a variety of ways to carry out the method. The method 300 described below can be carried out using the configurations illustrated in FIGS. 1 and 2 for example, and various elements of these figures are referenced in explaining example method 300. Each block shown in FIG. 3 represents one or more processes, methods, or subroutines carried out in the exemplary method 300. Additionally, the illustrated order of blocks is by example only and the order of the blocks can be changed. The exemplary method 300 can begin at block 301. Depending on the embodiment, additional steps can be added, others removed, and the ordering of the steps can be changed.

In block 301, an execution module executes a data recovery program of a distributed file system (DFS) to periodically (e.g., one hour) generate backup data of the DFS, and stores creation time of the backup data. The execution module stores the backup data of the DFS in a storage device of a computing device.

In block 302, a user of client device can do operations on data of the DFS. The computing device can receive the operations. In response to the received operations, a storing module stores information in relation to the received operations. The storing module can store the information by a way of log. The stored information includes, but is not limited to, operation time and a name of a client device corresponding to each of the received operations.

The received operations include a data adding operation, a data modification operation. The data adding operation includes uploading data to the DFS. The modification operation includes, but is not limited to, creating a folder, data cancellation and modifying a name of a file. In at least one embodiment, the storing information in relation to each of the received operations can be as followed. The storing module determines whether one received operation is the data adding operation or the data modification operation. When the received operation is the data adding operation, the storing module backups added data in the storage device. When the received operation is the data modification operation, the storing module stores modified data in the storage device.

In block 303, a determination module determines whether a master node of the DFS is abnormal. When the DFS runs normally, the determination module determines that the master node of the DFS is normal, a procedure of the recovery system ends. When the DFS cannot run or runs abnormally, the determination module determines that the master node of the DFS is abnormal, the procedure goes to block 304.

In block 304, when the master node of the DFS is abnormal, the execution module selects backup data whose creation time is closest to current time from the backup data of the DFS. The execution module executes the data recovery program to restore the data of the DFS using the selected backup data.

In block 305, the determination module determines specified operations whose operation time is later than the creation time of the selected backup data from the received operations and acquires information in relation to the specified operations from the stored information.

In block 306, the execution module re-executes each of the specified operations according to the acquired information in relation to the specified operations. In at least one embodiment, each of the specified operations can be re-executed as followed. The execution module determines one specified operation is the data adding operation or data modification operation. When the specified operation is the data adding operation, the execution module acquires added data corresponding to the specified operation from the storage device, and re-executes the specified operation according to the added data corresponding to the specified operation. When the specified operation is the data modification operation, the execution module acquires modified data corresponding to the specified operation from the storage device, and re-executes the specified operation according to the modified data corresponding to the specified operation.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A computer-implemented data recovery method for a distributed file system (DFS) using a computing device that is connected to a client device, the method comprising:
executing a data recovery program of the DFS to periodically generate backup data of the DFS;
storing information in relation to received operations in response to the received operations of a user on the DFS from the client device;
executing the data recovery program to restore data of the DFS using a selected backup data whose creation time is closest to a current time, when a master node of the DFS is abnormal;
determining specified operations whose operation time is later than the creation time of the selected backup data from the received operations and acquiring information in relation to the specified operations from the stored information in relation to the received operations; and
re-executing each of the specified operations according to the acquired information in relation to the specified operations.

2. The method according to claim 1, further comprising:
determining whether one received operation is a data adding operation or a data modification operation;
backing up added data in a storage device of the computing device when the received operation is the data adding operation; or
storing modified data in the storage device of the computing device when the received operation is the data modification operation.

3. The method according to claim 2, further comprising:
acquiring added data corresponding to one specified operation from the storage device and re-executing the specified operation according to the added data corresponding to the specified operation when the specified operation is the data adding operation; or
acquiring modified data corresponding to one specified operation from the storage device and re-executing the specified operation according to the modified data corresponding to the specified operation when the specified operation is the data modification operation.

4. The method according to claim 2, wherein the added data comprises uploaded data which are uploaded to the DFS.

5. A computing device comprising:
a processor; and
a storage device, when executed by the at least one processor, cause the at least one processor to:
execute a data recovery program of the DFS to periodically generate backup data of the DFS;
store information in relation to received operations in response to the received operations of a user on the DFS from the client device;
execute the data recovery program to restore data of the DFS using a selected backup data whose creation time is closest to a current time, when a master node of the DFS is abnormal;
determine specified operations whose operation time is later than the creation time of the selected backup data from the received operations and acquire information in relation to the specified operations from the stored information in relation to the received operations; and
re-execute each of the specified operations according to the acquired information in relation to the specified operations.

6. The computing device according to claim 5, wherein the at least one processor is caused to determine whether one received operation is a data adding operation or a data modification operation;
backup added data in a storage device of the computing device when the received operation is the data adding operation; or
store modified data in the storage device of the computing device when the received operation is the data modification operation.

7. The computing device according to claim 6, wherein the at least one processor is caused to:
acquire added data corresponding to one specified operation from the storage device and re-execute the specified operation according to the added data corresponding to the specified operation when the specified operation is the data adding operation; or
acquire modified data corresponding to one specified operation from the storage device and re-execute the specified operation according to the modified data corresponding to the specified operation when the specified operation is the data modification operation.

8. The computing device according to claim 6, wherein the added data comprises uploaded data which are uploaded to the DFS.

9. A non-transitory storage medium having stored thereon instructions that, when executed by a processor of a computing device, causes the processor to perform a recovery method, wherein the method comprises:
executing a data recovery program of the DFS to periodically generate backup data of the DFS;
storing information in relation to received operations in response to the received operations of a user on the DFS from the client device;
executing the data recovery program to restore data of the DFS using a selected backup data whose creation time is closest to a current time, when a master node of the DFS is abnormal;
determining specified operations whose operation time is later than the creation time of the selected backup data from the received operations and acquiring information in relation to the specified operations from the stored information in relation to the received operations; and
re-executing each of the specified operations according to the acquired information in relation to the specified operations.

10. The non-transitory storage medium according to claim 9, wherein the method comprises:
determining whether one received operation is a data adding operation or a data modification operation;
backing up added data in a storage device of the computing device when the received operation is the data adding operation; or
storing modified data in the storage device of the computing device when the received operation is the data modification operation.

11. The non-transitory storage medium according to claim 10, wherein the method comprises:
acquiring added data corresponding to one specified operation from the storage device and re-executing the specified operation according to the added data corresponding to the specified operation when the specified operation is the data adding operation; or
acquiring modified data corresponding to one specified operation from the storage device and re-executing the specified operation according to the modified data corresponding to the specified operation when the specified operation is the data modification operation.

12. The non-transitory storage medium according to claim 10, wherein the added data comprises uploaded data which are uploaded to the DFS.
